(19) United States
(12) Patent Application Publication
(10) Pub. No.: US 2009/0302863 A1
(43) Pub. Date: Dec. 10, 2009

(54) Device for Simulating the Symmetrical and Asymmetrical Impedance of an Asynchronous Motor

(76) Inventors: Marcus Schinkel, Bestensee (DE); Stephan Guttowski, Berlin (DE); Stefan-Peter Weber, Berlin (DE)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/224,589

(22) PCT Filed: Mar. 8, 2007
(86) PCT No.: PCT/DE2007/000424

§ 371 Date: Jun. 17, 2009

(30) Foreign Application Priority Data
Mar. 8, 2006 (DE) 10 2006 010 737.3

(51) Int. Cl. G09B 23/00

(52) U.S. Cl. 324/555; 324/76.11

(57) ABSTRACT

The present invention relates to a device for simultaneous simulation of a symmetrical and an asymmetrical impedance of an asynchronous machine. The device has three subcircuits for simulating the three phases of the asynchronous machine. Each subcircuit preferably comprises a series connection of a main inductance, a leakage inductance and a resistor between the input terminal and the output terminal, which are connected in parallel to ground across a capacitor and a resistor in each case. A magnetic coupling is implemented or the effect of a magnetic coupling is simulated for the main inductances of the subcircuits. This device can be used to advantage instead of the asynchronous machine in calibration of EMC filters.

### TECHNICAL FIELD OF APPLICATION

The present invention relates to a device for simulating the symmetrical and asymmetrical impedance of a three-phase asynchronous machine, in particular in the frequency range of EMC (electromagnetic compatibility) of 10 kHz to 30 MHz.

### STATE OF THE ART

Models for electronic components and modules for simulation have been known for several decades. This also relates to various models for asynchronous machines such as the modeling approach by Boglietti et al. “Induction Motor High Frequency Model” in Industry Applications Conference 1999, 34^{th} IAS Annual Meeting Conference Report of the IEEE, vol. 3, 1999, pages 1551 to 1558. Parameterization is performed with such models on the basis of the impedance measurement on a machine to be simulated in the frequency range. In the past, however, there has not been a model for an asynchronous machine that allows a good simulation of both the symmetrical and the asymmetrical frequency-dependent impedance of an asynchronous machine and therefore allows a practical implementation in hardware. For example, it is impossible with the Boglietti model to simulate the symmetrical impedance simultaneously with the asymmetrical impedance with sufficient accuracy.

EMC filters for three-phase variable-speed drive systems (converter-machine systems) are usually calibrated by the filter manufacturer. In addition to the converter, the filter manufacturer requires the proper motor for this. This leads not only to acquisition costs but also substantial logistics costs because of the great weight and volume of the motor. For example, the weight of a 15 kW converter is 5 kg, but the weight of a 15 kW asynchronous machine is 300 kg.

The object of the present invention is to provide a device for simulating the frequency-dependent impedance of an asynchronous machine, which adequately simulates both the symmetrical and the asymmetrical response of the frequency-dependent impedance and can be achieved with a small number of components.

### EXPLANATION OF THE INVENTION

This object is achieved with the device according to patent Claim 1. Advantageous embodiments of the device are the subject matter of the subclaims or can be derived from the following description and the exemplary embodiment.

The proposed device for simulating the frequency-dependent impedance of an asynchronous machine includes three subcircuits for simulating the three phases of the asynchronous machine, each having an input terminal and an output terminal. Each of the subcircuits has a total inductance between the input terminal and the output terminal, preferably as a series connection of a main inductance and a leakage inductance, wired in parallel with the resistor. The input side and the output side are each connected in series to ground and/or reference potential across a capacitance and a resistance. For the main inductances of the subcircuits, a magnetic coupling is implemented or the effect of a magnetic coupling is simulated.

With this embodiment of the device, it is possible to completely simulate the impedance, i.e., the frequency-dependent resistance, of an asynchronous machine in a certain frequency range, such as from 10 kHz to 30 MHz. For the simulation, the impedance is first measured on the asynchronous machine to be simulated to determine the required characteristic values of the individual components of the device. The term “completely” here is understood to refer to the impedance with regard to the lines in relation to one another as well as the impedance of the lines to ground and/or to the reference potential. The device can be implemented with a reasonable component expense, such that the device comprises only 24 components in an advantageous embodiment. The device can therefore be manufactured and handled much less expensively than the original motor.

The frequency-dependent resistance of an asynchronous machine has major effects on the electromagnetic compatibility of a drive system. A preferred use of the device therefore comprises the use of the device instead of the asynchronous machine whose response it simulates to calibrate and dimension EMC filters. This greatly reduces the cost for the filter manufacturer, because the original machine need no longer be acquired and shipped.

With the present device, the nonmagnetically coupled inductive component is preferably simulated by a leakage inductance in each subcircuit, which is connected in series with the main inductance.

In one embodiment of the proposed device, the main inductances are formed by separate cores and/or coils, each of which preferably includes two windings (with the number of windings selected to correspond to the characteristic values). This allows simulation of the coupling formed by all three phases. An inductance here acts on two phases and couples them. Consequently three inductances are needed to couple all three phases. Each of the inductances is wound in phase opposition.

In another embodiment of the present device, the electric current through the individual subcircuits is limited with low frequencies having an additional resistor connected in series with the main inductance. Since this resistor must not have any effect on the impedance at high frequencies (>150 kHz), its value is selected to be low accordingly.

### BRIEF DESCRIPTION OF THE DRAWINGS

The present device is explained in greater detail below again on the basis of an exemplary embodiment in conjunction with the drawings, in which:

FIG. 1 shows a schematic diagram as the basis for the present device;

FIG. 2 shows a schematic diagram for the three main inductances with three cores;

FIG. 3 shows an example of a schematic of the device;

FIG. 4 shows a photograph of the device, and

FIG. 5 shows a comparison of the interference spectra when using the original motor and the simulation.

### METHODS OF EMBODYING THE INVENTION

In the implementation of the proposed device, first an equivalent network and/or model was developed that would be capable of completely simulating the frequency-dependent symmetrical and asymmetrical impedance of an asynchronous machine in the frequency range from 10 kHz to 30 MHz. The asymmetrical impedance has a capacitive response over wide frequency ranges, with a lower capacitance being effective in the high-frequency range than in the lower-frequency range. The symmetrical impedance initially has an inductive response and then also has a capacitive response at higher frequencies. The symmetrical inductance is more effective than the asymmetrical inductance. It has been concluded from this that the three inductances of the respective phase must be magnetically coupled. At very high frequencies, both impedances have an inductive response. By combining these observations, the schematic diagram depicted in FIG. 1 was generated. The left part of the figure refers to one phase while the right of the figure refers to all three phases. The losses are not shown for reasons of simplicity.

Although it is a performance model, a physical significance can be assigned to the respective equivalent components. For example C_{g1} and C_{g2} represent the capacitance between the winding and the stator laminated package. R_{g1} and R_{g2} simulate the resistance of the iron path. L_{d} and M represent the magnetically coupled inductances of the individual phases, and Rₑ denotes the respective losses. Lead inductance L_{zu} represents the inductance of the connecting cable inside the motor. There is no simulation of the ohmic copper losses because their effect is negligible in the frequency range in question. However, despite these possible interpretations, this is not a physical model because parameterization is performed exclusively on the basis of the impedance, i.e., the frequency response, and a correlation with physical parameters such as geometry is impossible.

For parameterization of the model, the symmetrical and asymmetrical impedances of the motor to be modeled are measured. Then the corresponding values are read out from the measurements and the model parameters are ascertained subsequently on the basis of these values. To do so, for example, significant points in the measured symmetrical and asymmetrical impedances which have the most unambiguous possible response may be considered. This is the case with a capacitive response, with a declining impedance and a phase ratio of −90°. With an inductive response, the impedance increases and the phase ratio is +90°. Under some circumstances, not enough information about the system is available in this way, so the resonance positions are additionally analyzed. Parallel resonances (local impedance maximum) and series resonances (local impedance minimum) occur here. In conjunction with the capacitances and inductances determined in advance from the measurements, additional components can be parameterized in this way. In conclusion, the losses in the form of resistances at the respective resonance sites are taken into account. Based on a symmetrical design of the asynchronous machine, an equal distribution of all parameters among the three phases is assumed.

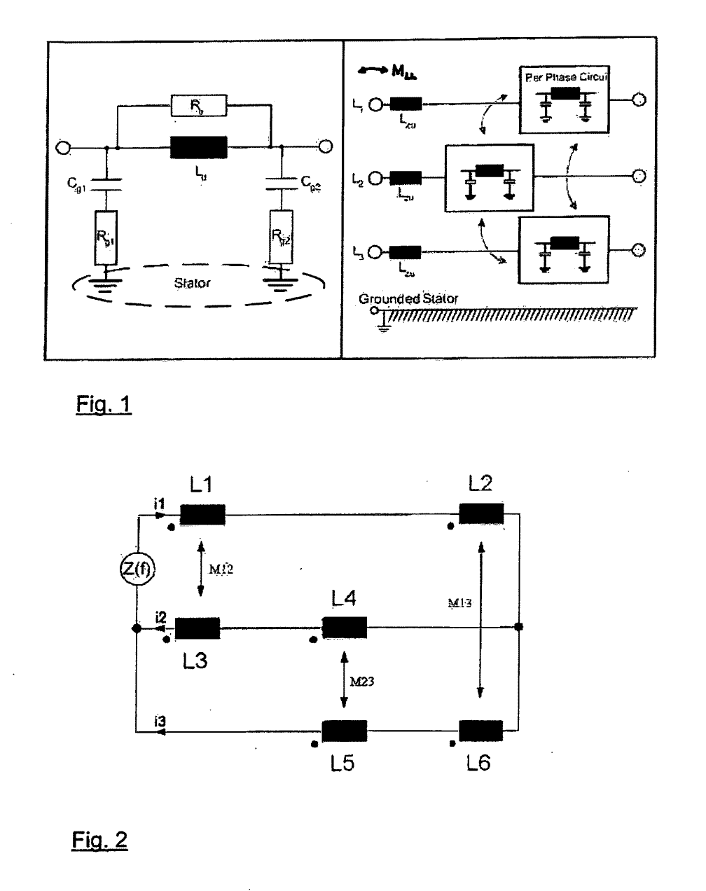

On the basis of the parameterized model, i.e., equivalent circuit diagram presented here, an example of a design of the present device is described below. The essential element for implementation of the motor simulation is the main inductance. Special demands are made of this because it must create the correct impedance for the motor simulation in the symmetrical case as well as in the asymmetrical case. A three-phase transformer design which makes it possible to add up the flows induced at any point in time is required. The three-phase transformer is broken down into three throttles, each with two windings, as shown in FIG. 2. The direction of flow can be adjusted in any way in each phase through the direction of winding, so the individual flows are added up at each point in time. For the practical implementation, three coils with corresponding cores are therefore required (for L1/L3, for L4/L5 and for L2/L6). The portion not coupled is simulated separately with a throttle in the proposed implementation.

In the present example, the main inductance is implemented with the W848 core from the company Vacuumschmelze [Vacuum Melt Co.]. This ring core comprises a nanocrystalline material. The core is characterized by a very high saturation induction and very low core losses. For the main inductance of L_{M}=|M|=2 mH which is required for simulation of a 15 kW asynchronous machine and 11 windings are needed for an A_{L} value of the coil core of 26 μH. Two coils each with 11 windings are applied to a core accordingly.

The leakage inductance L_{Str} is achieved with the material 893 from the company Vogt. This ring core is made of iron powder. The core is characterized by a very high saturation inductance and very low core losses. For the required inductance of L_{Str}=L_{d}−|M|=4.6 mH and an A_{L} value of the coil core of 281 μH, 68 windings are needed. A coil with 68 windings is therefore applied to the core.

The core dimensions are such that saturation is never achieved. At 280 nH, the feeder inductance L_{zu} is so low that it is implemented as an air coil. The coil is wound with a diameter of approx. 1 cm, measured and shortened until achieving the required value.

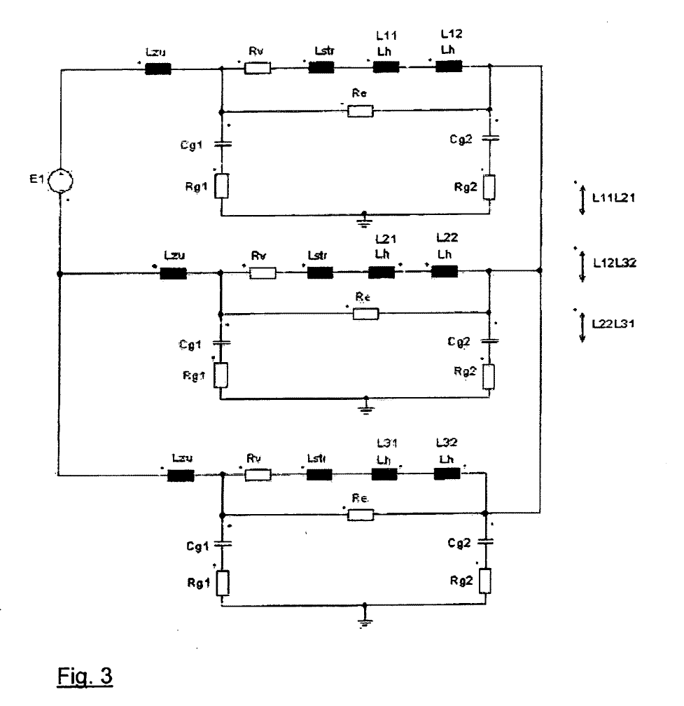

SMD component designs are used for the components C_{g1}, C_{g2}, R_{g1} and R_{g2} because they have a largely ideal response. The capacitors must have a sufficiently high voltage strength because the full operating voltage is applied to them. SMD resistors are used for R_{g1} and R_{g2} because their power loss is induced by low-energy high-frequency signal components and is not exceeded. The low-frequency signal components are compensated by the respective capacitors. Since the values for the resistors that were determined previously are not always available, the desired values can be approximated through suitable parallel connection of capacitors and/or resistors. The resistors Rᵥ and Rₑ which are also shown in FIG. 3 are power resistors because the losses occurring on them are substantial. The total current (max. 0.45 A) flows through Rᵥ (680Ω) per phase. This causes a maximum power loss of pᵥ=138 W. For this reason, Rᵥ must be mounted on a heat sink. Rₑ represents the losses of the magnetic components and is thus responsible for the damping of the resonances. In this example, it was dimensioned experimentally at 8 kΩ with a power loss of 2 W.

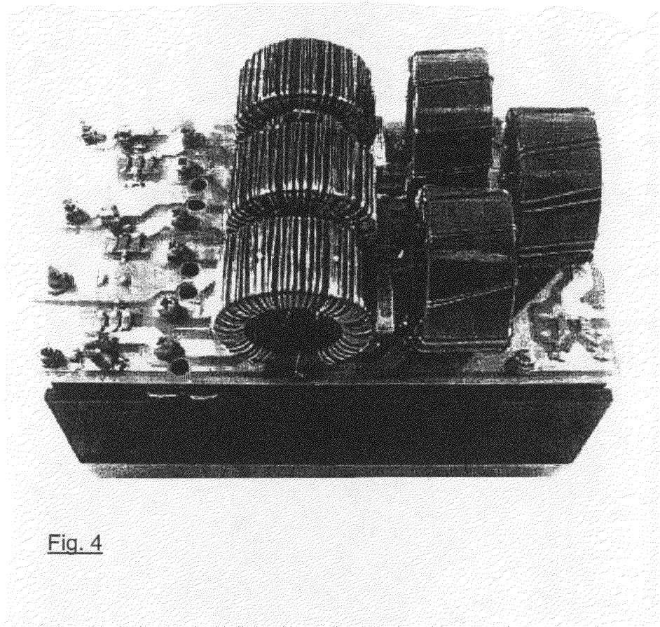

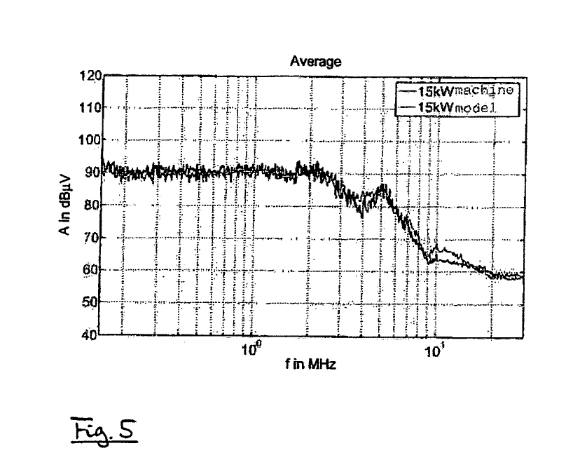

FIG. 3 shows the complete wiring diagram of the motor simulation of the present example. The configuration of components in the layout of the motor simulation follows the configuration of the wiring diagram. In this layout, the lines were made as short as possible to avoid influences due to line inductance. In the foreground, however, there is adequate insulation distance and an adequate current carrying capacity due to the wide printed conductors. The coupling of the leakage inductances through the geometric configuration is very minor in relation to the main inductance. FIG. 4 shows a photograph of the practical simulation of an asynchronous machine according to the present example. The complete device consists of only 24 components. On the left side are the large-area screw connections for the three phases and ground. The feeder inductances are designed to be relatively small as air coils. Somewhat farther to the right are the C_{g1} and R_{g1} as SMD components for each phase. This is followed by the series power resistors Rᵥ, only the screws of which can be seen because they are situated on the back of the heat sink. Then the three large coils for the leakage inductance and the arrangement of the three additional coils on the right side to achieve the main inductance can be seen in the layout. The power resistors Rₑ are between the coil groups. C_{g2} and R_{g2} are on the right side.

A 15 kW asynchronous machine is simulated with this device. The original machine weighs approximately 300 kg. The simulation weighs less than 3 kg and has a volume of 12×21×13 cm³, which amounts to only a fraction of the motor volume. An adaptation to other motor power classes is possible with no problem.

FIG. 5 shows a comparison of the interference spectra when using the simulated asynchronous machine and the simulation, i.e., the device presented in this example. The measurements were performed in a standardized design to ensure comparability. The correspondence is very good, as is readily discernible from the comparative measurement. The slight deviations in the range above 10 MHz may be disregarded and are of no meaning in practice. Since only the high-frequency response is simulated, only a fraction of the load current actually flows. The simulation has been designed accordingly.

Using such a device which simulates the frequency-dependent impedance response of an asynchronous machine, i.e., an asynchronous motor, measurements of line-guided interference in an asynchronous machine in the frequency range of the EMC can be conducted advantageously. This device is suitable in particular for manufacturers of EMC filters to be able to calibrate the corresponding filters using this device.

1. A device for simultaneous simulation of the symmetrical and asymmetrical impedance of an asynchronous machine,
each having one subcircuit per phase of the asynchronous machine, each having one input terminal and one output terminal,
such that between the input terminal and the output terminal, each subcircuit has a total inductance, which is connected at the input and output terminals to a reference potential across a capacitance and a resistor, and such that for a main inductance of the subcircuits, a magnetic coupling is implemented or the effect of a magnetic coupling is simulated,
characterized in that
the main inductance of each subcircuit is formed by a coil having two windings, wherein the two windings are wound in opposite directions of winding.

2. The device according to claim 1,
wherein the total inductance is formed by a separate main inductance and leakage inductance in each subcircuit.

3. The device according to claim 2,
wherein the main inductance is formed by multiple cores or coils.

4. The device according to claim 3,
wherein a resistor is connected in series with the main inductance in each subcircuit.

5. The device according to claim 1,
wherein the main inductance is formed by multiple cores or coils.

6. The device according to claim 1,
wherein a resistor is connected in series with the main inductance in each subcircuit.

7. The device according to claim 1,
wherein the total inductance is formed by a separate main inductance and leakage inductance in each subcircuit; and
wherein a resistor is connected in series with the main inductance in each subcircuit.

8. The device according to claim 1,
wherein the main inductance is formed by multiple cores or coils; and
wherein a resistor is connected in series with the main inductance in each subcircuit.
